(19) United States
(12) Patent Application Publication
(10) Pub. No.: US 2026/0365895 A1
(43) Pub. Date: Nov. 19, 2026

(54) FREE-RADICAL POLYMERISATION OF UV-CROSSLINKING SILANE ACRYLATES IN AN ISOCYANATE-CONTAINING POLYURETHANE MATRIX

(71) Applicant: FOLLMANN GMBH & CO. KG, Minden (DE)

(72) Inventors: Jörn KÜSTER, MINDEN (DE); Anton KLEMUSCH, MINDEN (DE); Christine ZWEIGERT, MINDEN (DE)

(21) Appl. No.: 19/121,836

(22) PCT Filed: Oct. 18, 2023
(86) PCT No.: PCT/EP2023/078938

§ 371 Date: Apr. 17, 2025

(30) Foreign Application Priority Data
Oct. 21, 2022 (DE) 10 2022 127 933.2

(51) Int. Cl. C09J 175/04; C08G 71/04; C09D 175/04

(52) U.S. Cl. CPC C09J 175/04; C08G 71/04; C09D 175/04

(57) ABSTRACT

The present invention relates to a process for production of a polymer composition in which a silane-modified polymer is polymerized by radical chain polymerization with an ethylenically unsaturated monomer and another ethylenically unsaturated polymer having a radical photo-initiator group in a polyol or in a prepolymer having terminal isocyanate groups, and to a polymer composition produced by this process. The invention further relates to a process for producing a moisture-curing polyurethane hot melt adhesive composition, a 1K polyurethane adhesive and a 2K polyurethane adhesive based on the polymer composition according to the invention. The invention further relates to the moisture-curing polyurethane hot melt adhesive composition produced by the processes, the 1K polyurethane adhesive and the 2K polyurethane adhesive.

The present invention relates to a process for production of a polymer composition in which a silane-modified polymer is polymerized by radical chain polymerization with an ethylenically unsaturated monomer and another ethylenically unsaturated polymer having a radical photo-initiator group in a polyol or in a prepolymer having terminal isocyanate groups, and to a polymer composition produced by this process. The invention further relates to a process for production of a moisture-curing polyurethane hot-melt adhesive composition, a 1K polyurethane adhesive and a 2K polyurethane adhesive, based on the polymer composition of the invention together with the moisture-curing polyurethane hot-melt adhesive composition produced therewith, the 1K polyurethane adhesive and the 2K polyurethane adhesive.

### BACKGROUND OF THE INVENTION

Depending on use, adhesives may require a long open time because the joining process is often performed manually. At the same time, quick adhesion is required after joining because the joined parts need to be processed further as quickly as possible. In polyurethane adhesives, this dilemma is solved, for example, through the use of acrylate polymer in powder form in polyether-based polyurethane. The latter enables a long open time, while the acrylate polymer ensures high initial adhesion. Incorporating the acrylates is often problematic because they add a lot of air and are difficult to dissolve. The solution is to polymerize the acrylate polymers directly in a polyol, which is then converted into polyurethane. This process also enables the use of acrylate polymers whose glass transition temperatures are below room temperature. Furthermore, these can be modified as needed with co-monomers. However, the characteristics of the adhesives are limited because the acrylate polymer is a thermoplastic that softens at higher temperatures or sometimes has a lower resistance to certain chemicals.

In summary, the resistance of reactive adhesives to temperature and certain chemicals is weakened by the use of thermoplastic materials such as acrylate polymers. Furthermore, adhesion of inorganic materials without surface treatment with polyurethane adhesives causes adhesion issues.

U.S. Pat. No. 5,021,507 A pertains to acrylic-modified reactive urethanes and teaches in column 2, lines 58 to 68 that for ethylenically unsaturated monomers with moisture-reactive functional groups, the monomers must be added only after the prepolymer has been formed and then polymerized only by means of free-radical polymerization.

Further prior art can be found in U.S. Pat. No. 5,018,337, WO 2016/123418 A1, or WO 01/81495 A2.

The present invention is based on the applicant's PCT/EP2022/060648, which relates to a polymerization of a silane-modified polymer formed by radical chain polymerization in a polyol or in a prepolymer with terminal isocyanate groups, which is then used in polyurethane formulations. Through use of polysilane acrylates in the polyurethane adhesive, the viscosity is reduced depending on the silane content and thus also the initial strength. In contrast, the system achieves the opposite effect in terms of final strength. Moisture cross-linking in a polyurethane adhesive occurs primarily through the reaction of the isocyanate groups and secondarily through the silane groups and thus leads to longer pressing times for bonds, which can be a disadvantage depending on the application.

The present invention is based on the object of improving the prior art or offering an alternative.

### SUMMARY OF THE INVENTION

According to a first aspect of the present invention, the issue is solved by means of a process for the preparation of a polymer composition according to Claim 1. Further embodiments are the subject of the further independent and dependent claims.

In a first aspect, the invention relates to a process for production of a polymer composition, which comprises the following steps:
a) Combining:
   (i) a polyol or a prepolymer with terminal isocyanate (NCO) groups
   (ii) an ethylenically unsaturated monomer containing no active hydrogen and having no moisture-reactive functional groups (monomer type A), and
   (iii) an ethylenically unsaturated, non-active hydrogen-containing monomer with a moisture-reactive functional group (monomer type B);
   (iv) an ethylenically unsaturated monomer containing no active hydrogen and having a radical photoinitiator group (monomer type C);
b) polymerization of the mixture from step a) using a radical polymerization process with a chain transfer agent to obtain a low-molecular-weight polymer;
c) optional heating of the mixture from step b) to a temperature of 100-160 °C for 10-60 minutes to partially cross-link the polyol or the prepolymer with terminal NCO groups with the low-molecular-weight polymer.

With regard to terminology, the following should be explained:

The ethylenically unsaturated group allows the radical polymerization of the monomers to form a polymer. The absence of active hydrogen in the monomers ensures that the monomers do not take part in the subsequent additive reaction to form the polyurethane. Monomer type A contributes to the structure of the polymer chain, monomer type B allows, through the moisture-reactive group, a reaction with the polyol or the isocyanate groups of the prepolymer, with the moisture-reactive groups of the polymer or in the application, such as with inorganic substrates to improve adhesion on these substrates.

The monomer type C introduces a photoreactive group into the polymer, which enables curing by means of UV radiation. In the present invention, moisture cross-linking through silane or isocyanate groups is combined with rapid UV cross-linking through radical polymerization. It is therefore called a “UV moisture dual-cure” system. In the strict sense, it is even a “triple-cure system”, because three cross-links are used: primarily through UV cross-linking, secondarily through the reaction of the isocyanate groups and tertiarily through the silane groups.

The “UV moisture dual-cure” systems of the present invention primarily offer the advantage of UV curing of UV-active groups and secondarily through the moisture-cross-linking groups. This makes it possible to generate particularly rapid initial strength using UV light for low-viscosity adhesives, such as to significantly shorten the process times in surface lamination. In the case of transparent materials such as transparent films, subsequent cross-linking using UV light is also possible after surface lamination.

The polymer according to the invention produced using monomers with ethylenically unsaturated groups, which is preferentially an acrylate polymer, is also referred to below as an ethylene-based polymer.

Modifying the ethylene-based polymer, which is preferentially an acrylate polymer, with silanes allows them to react with moisture after application and thereby become cross-linked. This leads to an increase in resistance to heat and certain chemicals. In addition, silanes react with inorganic materials, such as glass or metal, thereby increasing adhesion to them. This also means that the area of application of these adhesives can be expanded. Through application of additional heat, cross-linking can be accelerated and a permanently sticky adhesive polymer film is formed. Furthermore, it is also possible to produce reactive adhesives that do not contain any monomeric isocyanates and are therefore not subject to labeling requirements. This enables safe handling of the adhesives and does not require any laborious measures during use.

The polymers can be used for adhesives, sealants, and coatings, reactive hot melt adhesives, textile adhesives, adhesives for the wood & furniture sector, automotive adhesives, adhesives in the construction sector, liquid 1K adhesives, sealants, primers, and coatings.

The basic technical idea of the invention is based on modification of ethylene-based polymers and, in particular, acrylate polymers with silanes in order to improve the characteristics profile. Possible improvements could be the following:
Increase in temperature resistance through cross-linking of the silanes
A reaction of the silanes with inorganic substrates to improve adhesion to them
Possible production of products with isocyanate monomer concentrations below 0.1%, which are therefore not subject to labeling requirements
A particularly fast initial strength that can be controlled by UV light

The invention has several advantages over the prior art. Thermoplastic acrylate polymers are converted into reactive polymers that react with moisture to form thermosets and therefore have greater resistance to heat and special chemicals. Since the silane groups are statistically distributed across the polymer and not just terminal, as is the case with polyaddition products or subsequent silanization, the cross-linking density and thus the durability of the material is increased. Silanes also offer the possibility of reacting with inorganic materials, such as glass or metals in order to increase the adhesion strength to these materials, which expands the adhesion spectrum or enables the adhesion of inorganic materials to organic materials such as plastics. Furthermore, three synthetic pathways are available, which also allow production of materials without isocyanate monomers. This means that these products are not subject to labeling requirements or any restrictions.

The present polymer composition can be used as a novel intermediate for production of various polyurethanes. In particular, the following possibilities arise:
Preparation of a silane-modified ethylene-based polymer (preferentially as an acrylate polymer) in a polyol or in a prepolymer with terminal NCO groups, with subsequent reaction of the polyol or the prepolymer with terminal NCO groups to form a thermoplastic polyurethane
Preparation of a silane-modified ethylene-based polymer (preferentially as an acrylate polymer) in a polyol or in a prepolymer with terminal NCO groups, with subsequent reaction of the polyol or the prepolymer with terminal NCO groups to form a thermoplastic polyurethane
Preparation of a silane-modified ethylene-based polymer (preferentially as an acrylate polymer) in a polyol or in a prepolymer with terminal NCO groups, with subsequent reaction of the polyol or the prepolymer with terminal NCO groups to form a reactive polyurethane, which is then reacted with aminosilanes or mercaptosilanes to form a silane-terminated polyurethane

### INVENTION IN DETAIL

Polymerization according to the invention of monomer type A with monomer types B and C is generally done by combining all monomers into the reaction vessel and allowing them to react randomly according to their relative concentrations and relative reactivity, enabling the formation of statistical polymers. However, to increase or reduce the non-uniformity of the polymers, one or more of the ethylenically unsaturated monomers can also be added during polymerization.

Alternatively, the monomers of monomer type A to monomer type C can be added gradually, so that the radical polymerization is started after addition of a defined mixture of monomer type A to monomer type C, and only after polymer formation, which is accompanied by almost complete consumption of the monomers, is a defined mixture of monomer type A to monomer type C added to the reaction mixture again. The step-by-step addition prevents the reaction mixture from overheating due to the exothermic polymerization reaction.

The radical polymerization process is preferentially performed at a temperature of less than 100 °C, further preferentially at a temperature of 40-95 °C, and particularly preferentially at a temperature of 8090 °C.

It is preferred here if the weight ratio of monomer type A to monomer type C defined in the first step is also maintained in the second addition.

It is also conceivable that the amount of monomer type A in the second step is greater than the amount of monomer type A in the first addition. The quantitative ratio of monomer type A_{first addition} to monomer type A_{second addition} is preferentially between 1:1 and 1:10, further preferentially between 1:2 and 1:8, and particularly preferentially between 1:3 and 1:7.

Accordingly, it is conceivable that the amount of monomer type B in the second step is greater than the amount of monomer type B in the first addition. The quantitative ratio of monomer type B_{first addition} to monomer type B_{second addition} is preferentially between 1:1 and 1:10, further preferentially between 1:2 and 1:8, and particularly preferentially between 1:35 and 1:7.

Accordingly, it is conceivable that the amount of monomer type C in the second step is greater than the amount of monomer type C in the first addition. The quantitative ratio of monomer type C_{first addition} to monomer type C_{second addition} is preferentially between 1:1 and 1:10, further preferentially between 1:2 and 1:8, and particularly preferentially between 1:35 and 1:7.

In the optional step (c) of the process, the mixture from step (b), which contains the low-molecular-weight polymer as a result of the radical polymerization, is heated so that the polyol or the prepolymer with terminal NCO groups is partially cross-linked with the low-molecular-weight polymer. Due to its moisture-reactive groups, the low-molecular-weight polymer can react with the hydroxyl groups of the polyol or the isocyanate groups of the prepolymer. This reaction results in a polymer composition with increased temperature resistance.

In the optional step (c), the silane groups can alternatively or additionally react with one another. This reaction also results in a polymer composition with increased temperature resistance.

According to the invention, a polyol or a prepolymer with terminal NCO groups is used in the process for production of the polymer composition.

As it pertains to the polyol, this is to be understood as meaning that at least one polyol can be used here, i.e. also two, three, four, or even more polyols. Preferentially, exactly one polyol is used in the process.

Expediently, the polyol used in the process according to the invention has a water content of maximum 0.1% by weight and preferentially maximum 0.05% by weight.

Suitable polyols are selected from the group consisting of polyester, polyether polyols such as polyethylene oxide or polypropylene oxide, hydroxyl group-containing polycaprolactone, polyoxyalkylene polyol (synonymous with the term “polyglycol”), monosubstituted glycol ester, polythioether, polyamide, polyesteramide, polycarbonate, polyacetal, polyhydrocarbon polyol, polyacrylate polyol, polymethacrylate polyol, polyalcohol, bisphenol, polycarbonate polyol, polyhydroxy-functional fats and oils and mixtures thereof.

Particularly suitable are polyether polyols such as diols with a molecular weight of 400 to 4000 g/mol or polypropylene glycol.

Suitable polyols are, on the one hand, the high-molecular polyoxyalkylene polyols already mentioned, preferentially polyethylene oxides or polyoxypropylene diols with a degree of unsaturation lower than 0.02 mEq/g and with a molecular weight in the range from 400-18,000 g/mol, in particular those with a molecular weight in the range from 1,000-4,000 g/mol. PPG 2000 or PPG 4000 are particularly suitable.

To achieve a higher cross-linking density, higher-quality alcohols such as triols and tetraols can also be used. Glycerin, trimethylolpropane, or pentaerythritol are mentioned here as examples.

Polyoxyalkylene polyols, which are also called polyether polyols, polyglycols or oligoetherols, are also suitable. These are polymerization products of ethylene oxide, 1,2-propylene oxide, 1,2- or 2,3-butylene oxide, oxetane, tetrahydrofuran or mixtures thereof, possibly polymerized with the help of a starter molecule with two or more active hydrogen atoms such as water, ammonia or compounds with one or more OH or NH groups such as 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, bisphenol A, hydrogenated bisphenol A, 1,1,1-trimethylolethane, 1,1,1-trimethylolpropane, glycerin, aniline, and mixtures of the aforementioned compounds.

Particularly suitable polyester polyols are those which are produced from dihydric to trihydric, especially dihydric, alcohols, such as ethylene glycol, diethylene glycol, propylene glycol, dipropylene glycol, neopentyl glycol, 1,4-butanediol, 1,5-pentanediol, 3-methyl-1,5-hexanediol, 1,6-hexanediol, 1,8-octanediol, 1,10-decanediol, 1,12-dodecanediol, 1,12-hydroxystearyl alcohol, 1,4-cyclohexanedimethanol, dimer fatty acid diol (dimerdiol), hydroxypivalic acid neopentyl glycol ester, glycerin, 1,1,1-trimethylolpropane or mixtures of the aforementioned alcohols, with organic di- or tricarboxylic acids, in particular dicarboxylic acids, or their anhydrides or esters, such as succinic acid, glutaric acid, adipic acid, trimethyladipic acid, suberic acid, azelaic acid, sebacic acid, dodecanedicarboxylic acid, maleic acid, fumaric acid, dimer fatty acid, phthalic acid, phthalic anhydride, isophthalic acid, terephthalic acid, dimethyl terephthalate, hexahydrophthalic acid, trimellitic acid and trimellitic anhydride, or mixtures of the aforementioned acids, as well as polyester polyols from lactones such as from ε-caprolactone and starters such as the aforementioned di- or trihydric alcohols.

The use of polycarbonate polyols is also conceivable, as can be obtained, for example, by reacting the alcohols mentioned above-used to form the polyester polyols—with dialkyl carbonates, diaryl carbonates, or phosgene.

Also suitable are polyhydroxy-functional fats and oils, e.g., natural fats and oils, especially castor oil, or polyols obtained by chemical modification of natural fats and oils—called oleochemical—such as the epoxy polyesters or epoxy polyethers obtained by epoxidation of unsaturated oils and subsequent ring opening with carboxylic acids or alcohols, or polyols obtained by hydroformylation and hydrogenation of unsaturated oils, or polyols obtained from natural fats and oils by degradation processes such as alcoholysis or ozonolysis and subsequent chemical combination, e.g., by transesterification or dimerization, of the degradation products obtained in this way or derivatives thereof. Suitable degradation products of natural fats and oils are, in particular, fatty acids and fatty alcohols as well as fatty acid esters, in particular the methyl esters (FAME), which can be derivatized, e.g., by hydroformylation and hydrogenation to give hydroxy fatty acid esters.

It is also conceivable to use polyhydrocarbon polyols. These are also called oligohydrocarbonols and include, e.g., polyhydroxy-functional polyolefins, polyisobutylenes, polyisoprenes; polyhydroxy-functional ethylene-propylene, ethylene-butylene or ethylene-propylene-diene copolymers, such as are produced, e.g., by the company Kraton Polymers, polyhydroxy-functional polymers of dienes, in particular of 1,3-butadiene, which in particular can also be produced from anionic polymerization, polyhydroxy-functional copolymers of dienes such as 1,3-butadiene or diene mixtures and vinyl monomers such as styrene, acrylonitrile, vinyl chloride, vinyl acetate, vinyl alcohol, isobutylene, and isoprene, e.g., polyhydroxy-functional acrylonitrile/butadiene copolymers, such as those formed from epoxides or amino alcohols and carboxyl-terminated acrylonitrile/butadiene copolymers, and hydrogenated polyhydroxy-functional polymers or copolymers of dienes.

In addition to these mentioned polyols, small amounts of low-molecular-weight di- or polyhydric alcohols such as 1,2-ethanediol, 1,2- and 1,3-propanediol, neopentylglycol, diethyleneglycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, hydrogenated bisphenol A, dimeric fatty alcohols, 1,1,1-trimethylolethane, 1,1,1-trimethylolpropane, glycerol, pentaerythritol, sugar alcohols such as xylitol, sorbitol or mannitol, sugars such as sucrose, other higher alcohols, low-molecular-weight alkoxylation products of the above-mentioned dihydric and polyhydric alcohols, and mixtures of the above-mentioned alcohols are also used in the production of the polyurethane polymer containing isocyanate groups.

It is also conceivable that in addition to these polyols mentioned, small amounts of low-molecular-weight di- or polyvalent amines such as ethylenediamine, toluenediamine (TDA), diaminodiphenylmethane (DADPM), and polymethylene-polyphenylenamine or amino alcohols such as ethanolamine and diethanolamine, as well as mixtures of the aforementioned amines and amino alcohols are used in the production of the polyurethane polymer containing isocyanate groups.

A prepolymer with terminal NCO groups can also be used in the process for producing the polymer composition. This should be understood to mean that at least one corresponding prepolymer can be used here, including two, three, four, or even more prepolymers. Preferentially, exactly one prepolymer with terminal NCO groups is used in the process.

According to one advantage, the prepolymer with terminal NCO groups may be provided to have a molar ratio of NCO to OH groups of between 1.5 to 1 and 2.0 to 1.

In one embodiment, the prepolymer with terminal NCO groups is prepared by reacting a diol with diisocyanate.

Suitable polyols are selected from the group consisting of polyester, polycaprolactone containing hydroxyl groups, polyglycols, monosubstituted glycol esters, polythioethers, polyamide, polyesteramide, polycarbonate, polyacetal, polyhydrocarbon polyol, polyacrylate polyol, polymethacrylate polyol, polyalcohol, bisphenol, polycarbonate polyol, polyhydroxy-functional fats and oils, and mixtures thereof.

Diols, polyethylene oxides, or polypropylene oxides are particularly suitable.

Suitable polyols are, on the one hand, the high-molecular polyglycols already mentioned, preferentially polyethylene oxides or polyoxypropylene diols with a degree of unsaturation lower than 0.02 mEq/g and with a molecular weight in the range of 400-18,000 g/mol, in particular those with a molecular weight in the range of 1,000-4,000 g/mol. PPG 2000 or PPG 4000 are particularly suitable.

A mixture of polyols can also be used here. Preferentially, this is a mixture of two or more polyethylene oxides or a mixture of two or more polyoxypropylene diols. A mixture of PPG1000 and PPG 400 is particularly advantageous.

For production of the prepolymer with terminal isocyanate groups, the diisocyanates familiar to qualified experts in the production of polyurethane polymers can be used.

It may further be possible that the diisocyanate for this prepolymer synthesis is selected from the group consisting of ethylene diisocyanate, ethylidene diisocyanate, propylene diisocyanate, butylene diisocyanate, pentamethylene diisocyanate, hexamethylene diisocyanate, toluene diisocyanate, cyclopentylene-1,3-diisocyanate, cyclohexylene-1,4-diisocyanate, cyclohexylene-1,2-diisocyanate, 4,4′-diphenylmethane diisocyanate, 2,4′-diphenylmethane diisocyanate, 2,2′-diphenylmethane diisocyanate, 4,4′-diisocyanatodicyclohexylmethane, 2,2-diphenylpropane-4,4′-diisocyanate, p-phenylene diisocyanate, m-phenylene diisocyanate, xylylene diisocyanate, 1,4-naphthylene diisocyanate, 1,5-naphthylene diisocyanate, diphenyl 4,4′-diisocyanate, azobenzene 4,4′-diisocyanate, diphenyl sulfone 4,4′-diisocyanate, dichlorohexamethylene diisocyanate, furfurylidene diisocyanate, 1-chlorobenzene-2,4-diisocyanate, 1,3-bis(isocyanatomethyl)benzene, 1,3-bis(isocyanatomethyl)cyclohexane, block diisocyanates and carbodiimide-modified diisocyanates, and any mixtures of the above diisocyanates. Diphenylmethane diisocyanates are preferentially used here and 4,4′-diphenylmethane diisocyanate (4,4′-MDI) is particularly preferred.

In the radical polymerization process, an initiator which is a peroxide initiator or an azo initiator can be used. Preferential initiators are dilauroyl peroxide, dibenzoyl peroxide, dimethyl 2,2′-azobisisobutyrate, di-(4-tert-butyl-cyclohexyl)-peroxydicarbonate and azobis(isobutyronitrile). The use of dilauroyl peroxide is preferred.

During the photoreaction, monomer type A can serve as a co-initiator of UV curing through radical formation due to hydrogen radical abstraction. Tertiary amines or mercapto compounds can serve as additional co-initiators.

It is also conceivable that an auxiliary and/or an additive is added to the reaction mixture in the process of the invention. Examples include surface-active substances, fillers, other flame retardants, nucleating agents, oxidation stabilizers, slip and demolding aids, dyes and pigments, optionally stabilizers, e.g. against hydrolysis, light, heat or discoloration, inorganic and/or organic fillers, reinforcing agents, and plasticizers. Suitable auxiliaries and additives can be found, e.g., in the Plastics Handbook, Volume 7 “Polyurethanes,” Gerhard W. Becker and Dietrich Braun, Carl Hanser Verlag, Munich, Vienna, 1993.

To adjust the viscosity, a solvent can also be added to the reaction mixture at any time in the process of the invention. Examples of solvents include triethyl phosphate (TEP), pentamethyldiethylenetriamine (PMDETA), triethylenediamine (TEDA), monoethylene glycol, polyethylene glycol and propylene carbonate (PC), and mixtures of two or more of the aforementioned solvents. In case the solvent is a polyol, adding it after completion of the radical polymerization is favorable.

To accelerate the reaction, a catalyst can be added to the reaction mixture in the process of the invention.

For example, suitable catalysts include N,N-dimethylethanolamine (DMEA), N,N-dimethylcyclohexylamine (DMCHA), bis(N,N-dimethylaminoethyl)ether (BDMAFE), N,N,N′,N′,N″-pentamethyldiethylenetriamine (PDMAFE), 1,4-diazadicyclo[2,2,2]octane (DABCO), 2-(2-dimethylaminoethoxy)ethanol (DMAFE), 2-((2-dimethylaminoethoxy)ethylmethylamino)ethanol, 1-(bis(3-dimethylamino)propyl)amino-2-propanol, N,N′,N″-tris(3-dimethylamino-propyl)hexahydrotriazine, dimorpholinodiethyl ether (DMDEE), N. N-dimethylbenzylamine, N,N,N′,N″,N″-pentaamethyldipropylenetriamine, N,N′-diethylpiperazine. Particularly suitable are sterically hindered primary, secondary or tertiary amines such as dicyclohexylmethylamine, ethyldiisopropylamine, dimethylcyclohexylamine, dimethylisopropylamine, methylisopropylbenzylamine, methylcyclopentylbenzylamine, isopropyl-sec-butyl-trifluoroethylamine, diethyl-α-phenyethyl)amine, tris-n-propylamine, dicyclohexylamine, t-butylisopropylamine, di-t-butylamine, cyclohexyl-t-butylamine, de-sec-butylamine, dicyclopentylamine, di-α-trifluoromethylethyl)amine, di-(α-phenylethyl)amine, triphenylmethylamine, and 1,1,-diethyl-n-propylamine. Other sterically hindered amines include morpholines, imidazoles, ether compounds such as dimorpholinodiethyl ether or dimorpholinodimethyl ether; N-ethylmorpholine, N-methylmorpholine, bis(dimethylaminoethyl) ether, imidizoles, nomethylimidazoles, 1,2-dimethylimidazoles, N,N,N′,N′,N″,N″-pentamethyldiethylenetriamine, N,N,N′,N′,N″,N″-pentaethyldiethylenetriamine, N,N,N′,N′,N″,N″-pentamethyldipropylenetriamine, bis(diethylaminoethyl)ether, and bis(dimethylaminopropyl)ether.

According to the invention, monomer type A is an ethylenically unsaturated monomer that does not contain active hydrogen and has no moisture-reactive functional groups.

According to the invention, a monomer of monomer type A is used in the process for producing the polymer composition. This should be understood to mean that at least one monomer of this type can be used here, i.e., also two, three, four, or even more type A monomers. Preferentially, two monomers of monomer type A are used in the process.

Examples of monomer type A are selected from the group consisting of C1 to C12 esters of acrylic acid or methacrylic acid such as glycidyl acrylate, glycidyl methacrylate, methyl acrylate, ethyl acrylate, 2-ethylhexyl acrylate, n-butyl acrylate, methyl methacrylate, ethyl methacrylate, or n-butyl methacrylate, vinyl esters such as vinyl acetate, or vinyl propionate, vinyl ethers, fumarates, maleates, styrenes, acrylonitriles, ethylenes, or mixtures thereof.

Particularly suitable as monomer type A is n-butyl methacrylate or 2-ethylhexyl acrylate or a mixture thereof.

Monomer type A preferentially acts as a co-initiator in the photoreaction. By H abstraction it is converted into a radical and by reaction with the radical of monomer type C a covalent bond is preferentially formed between these monomers.

According to the invention, monomer type B is an ethylenically unsaturated monomer that does not contain active hydrogen and has a moisture-reactive functional group.

According to the invention, a monomer of monomer type B is used in the process for producing the polymer composition. This should be understood to mean that at least one monomer of this type can be used here, i.e., also two, three, four or even more type B monomers. Preferentially, exactly one monomer of monomer type B is used in the process.

Furthermore, it is advantageous if, within the scope of the invention monomer type B is selected from the group consisting of vinyl compounds, acrylates, methacrylates, fumarates, maleates, styrenes, acrylonitriles, ethylenes, or mixtures thereof, all having a moisture-reactive functional group.

A suitable moisture-reactive group is the isocyanate group or the silane group. Monomer type B preferentially has a silane group as a moisture-reactive group.

Advantageously, the invention may provide that monomer type B is selected from the group consisting of vinyltrichlorosilane, methylvinyldichlorosilane, vinyltriethoxysilane, vinyltrimethoxysilane, vinyltris(2-methoxyethoxy)silane, vinyltriacetoxy-silane, finylmethyldiethoxysilane, vinyldimethylethoxysilane, vinylmethyldimethoxysilane, vinyldimethylmethoxysilane, vinylmethyidiacetoxysilane, vinyltriisopropoxysilane, vinyltriiso-propenoxysilane, vinyltris(methyl ethyl ketoximino)silane, divinyltetramethyldisiloxane, tetra-vinyltetramethylcyclotetrasiloxane, 3-acryloxypropyldimethylmethoxysilane, 3-acryloxy-propyldimethylethoxysilane, 3-acryloxypropyltrimethoxysilane,3-acryloxypropyltriethoxysilane, 3-methacryloxypropyltrimethoxysilane, 3-methacryloxypropyltriethoxysilane, 3-methyacryloxypropylmethyldiethoxysilane, 3-methyacryloxypropylmethyldimethoxysilane, 3-methacryloxypropyl-tris(2 methoxyethoxy)silane, 4-(3-trimethoxysilylpropyl)benzylstyrene sulfonate, allyl-triethoxysilane, allyltrimethoxysilane, and oligomers of these silanes.

Methacryloxypropyltrimethoxysilane is particularly suitable as monomer type B.

According to the invention, monomer type C is an ethylenically unsaturated monomer that does not contain any active hydrogen and has a radical photoinitiator group. A radical photoinitiator group is defined in the context of the present invention as a functional group that decomposes in a photolysis reaction after absorption of UV light and thus forms a radical as a reactive species that can start (initiate) a polymerization reaction.

The term “UV light” is defined according to the present invention as light with a wavelength of less than 400 nm. Sub-ranges of the UV light used here are UVA radiation with a wavelength of between 315 nm and 400 nm, UVB radiation with a wavelength of between 280 nm and 315 nm and UVC radiation with a wavelength of between 100 nm and 280 nm. Preferentially, UVA and/or UVB radiation is used for UV-induced photolysis and thus for UV-induced curing.

According to the invention, a monomer of monomer type C is used in the process for preparing the polymer composition. This is to be understood to mean that at least one monomer of this type can be used here, i.e. also two, three, four or even more monomers of type C. Preferentially, exactly one monomer of monomer type C is used in the process.

In a preferential embodiment, the radical photoinitiator group of monomer type C is a radical photoinitiator group of type II. Type II photoinitiators abstract a hydrogen atom from a neighboring molecule. This launches chain polymerization.

The radical photoinitiator group of type II is preferentially a benzophenone group or an isopropylthioxanthone group.

Advantageously, the invention can provide that the monomer type C is selected from the group consisting of 4-methacryloyloxybenzophenone, 4-methacryloyloxyethoxybenzophenone, 4-methacryloyloxy-4′-methoxybenzophenone, 4-methacryloyloxyethoxy-4′-methoxybenzophenone, 4-methacryloyloxy-4′-bromobenzophenone, 4-acryloyloxyethoxy-4′-bromobenzophenone, 4-acryloyloxybenzophenone (ABP), 4-(2-acryloyloxyethoxy)benzophenone (AEBP), 4-(2-acryloyloxybutoxy)benzophenone (ABBP), 4-(2-acryloyloxyhexoxy)benzophenone (AHBP).

ABP or 4-methacryloyloxybenzophenone are particularly suitable as monomer type C.

According to the invention, a chain transfer agent is used as part of the radical polymerization process in order to reduce the average degree of polymerization of the finished polymer and to obtain a low-molecular-weight polymer. The person skilled in the art is familiar with chain transfer agents for radical polymerizations.

It may be advantageous if, within the scope of the invention, the chain transfer agent is a halogen-organic compound, an unsaturated aromatic compound or a thiol, which is preferentially selected from the group consisting of tetrachloromethane, 2,4-diphenyl-4-methyl-1-pentene, dodecyl mercaptan, lauryl mercaptan, thioglycolic acid, octyl thioglycolate and thioglycerol.

Preferentially, the chain transfer agent is dodecyl mercaptan.

It is further conceivable that in the process for preparing the polymer composition, the polyol is provided in an amount of from 20 percent by weight to 90 percent by weight, preferentially from 40 percent by weight to 80 percent by weight, and particularly preferentially from 50 percent by weight to 60 percent by weight, based on the total weight of the polyol, monomer types A to C components.

Accordingly, it is conceivable that in the process for producing the polymer composition, the prepolymer with the terminal NCO groups is present in an amount of from 20 percent by weight to 90 percent by weight, preferentially from 40 percent by weight to 80 percent by weight and particularly preferentially from 50 percent by weight to 60 percent by weight, based on the total weight of the components prepolymer, monomer type A, monomer type B and monomer type C.

In yet another embodiment, it may be provided that in the process for preparing the polymer composition, monomer type A is present in an amount of from 30 percent by weight to 95 percent by weight, preferentially from 50 percent by weight to 90 percent by weight, and particularly preferentially from 70 percent by weight to 85 percent by weight, based on the total weight of monomer types A to C.

It may further be possible that in the process for preparing the polymer composition, monomer type B is present in an amount of from 5 percent by weight to 70 percent by weight, preferentially from 10 percent by weight to 50 percent by weight, and particularly preferentially from 15 percent by weight to 30 percent by weight, based on the total weight of monomer types A to C.

In yet another embodiment, it may be provided that in the process for preparing the polymer composition, monomer type C is present in an amount of from 0.1 percent by weight to 5.0 percent by weight, preferentially from 0.2 percent by weight to 4.0 percent by weight, and particularly preferentially from 0.3 percent by weight to 3.0 percent by weight, based on the total weight of monomer types A, B and C.

According to a further advantage, it can be provided that the low-molecular-weight polymer has a number-average molecular weight of 3,000-200,000 g/mol, preferably of 5,000-100,000 g/mol, and particularly preferentially of 10,000-60,000 g/mol.

From a second aspect, the invention relates to a polymer composition that is preparable or prepared by the process according to the invention.

The synthesis according to the invention of the silane-modified ethylene-based polymer in a polyol results in a polymer composition with improved properties compared to a silane-modified ethylene-based polymer that is synthesized in the PU prepolymer. Structurally, in the polymer composition according to the invention, the formation of an interpenetrating network is advantageous for the physico-chemical properties. It exhibits increased temperature resistance and also improved sealing properties against oil.

If the optional step (c) is done according to the invention, this polymer composition is characterized in that the polyol or the prepolymer is partially cross-linked with the low-molecular-weight polymer formed by radical polymerization.

Preferentially, it may be provided that the polymer composition has a glass transition temperature of between −50 °C and 100 °C, preferentially between −40 °C and 70 °C, and particularly preferentially between −30 °C and 60 °C.

A further advantage can be achieved within the scope of the invention if it has a viscosity of 500-25.000 mPa·s, and preferentially of 1.000-21,000 mPa·s, measured at 90 °C.

It can be advantageous if the polymer composition within the scope of the invention is free of solvents. The further reaction with a polyisocyanate to form a polyurethane thus produces a solvent-free PU polymer.

Another object of the invention is the use of the polymer composition according to at least one of the preceding claims as an adhesive, sealant, or coating agent. In particular, it is provided that the polymer composition cures as a one-component composition with moisture and by increasing the temperature to more than 100 °C.

The invention also provides a process for producing a UV and moisture-curing polyurethane hot melt adhesive composition. The process includes the following steps:
a) Provision of a polymer composition according to the invention
b) Addition of sufficient polyisocyanate to achieve the desired isocyanate content and isocyanate index and polymerization through the use of an additive polymerization process
c) Optional addition of an aminosilane or a mercaptosilane and conversion to a silane-terminated polyurethane
d) Irradiation with UV light to further cross-link the polymer

By synthesizing the silane-modified ethylene-based polymer in a polyol according to the invention, a polyurethane hot melt adhesive composition with improved properties is obtained through the use of the polymer composition according to the invention compared to a silane-modified ethylene-based polymer that is synthesized in the PU prepolymer. The PU hot melt according to the invention has a higher temperature resistance, increased chemical resistance, and improved adhesion to inorganic materials. Furthermore, the resulting polymer composition exhibited improved sealing properties against oil. By using monomer type C, the polymer also becomes UV-curable, which enables rapid curing.

Commercially available polyisocyanates, in particular diisocyanates, can be used as polyisocyanates for the production of the polyurethane polymer.

It may further be possible that the polyisocyanate is selected from the group consisting of ethylene diisocyanate, ethylidene diisocyanate, propylene diisocyanate, butylene diisocyanate, pentamethylene diisocyanate, hexamethylene diisocyanate (HDI), toluene diisocyanate, cyclopentylene-1,3-diisocyanate, cyclohexylene-1,4-diisocyanate, cyclohexylene-1,2-diisocyanate, 4,4′-diphenylmethane diisocyanate, 2,4′-diphenylmethane diisocyanate, 2,2′-diphenylmethane diisocyanate, 4,4′-diisocyanatodicyclohexylmethane, 2,2-diphenylpropane-4,4′-diisocyanates, p-phenylene diisocyanates, m-phenylene diisocyanates, xylylene diisocyanates, 1,4-naphthylene diisocyanates, 1,5-naphthylene diisocyanate, diphenyl-4,4′-diisocyanate, azobenzene-4,4′-diisocyanate, diphenylsulfone-4,4′-diisocyanate, dichlorohexamethylene diisocyanate, furfurylidene diisocyanate, 1-chlorobenzene-2,4-diisocyanate, 4,4′,4″-triisocyanato-triphenylmethane, 1,3,5-triisocyanato-benzene, 2,4,6-triisocyanato-toluene and 4,4′-dimethyldiphenylmethane-2,2′,5,5-tetraisocyanate, 3-isocyanatomethyl-3,5,5-trimethylcyclohexyl isocyanate, 1,3-bis(isocyanatomethyl)benzene, 1,3-bis(isocyanatomethyl)cyclohexane, block diisocyanates and carbodiimide-modified polyisocyanates, as well as any mixtures and precondensates of the aforementioned isocyanates.

Examples of precondensates include HDI biuret and HDI cyanurate.

The polyisocyanate is preferentially an aliphatic isocyanate.

Advantageously, within the scope of the invention it can be provided that in the process for producing a moisture-curing polyurethane hot melt adhesive composition the free isocyanate content is between 0-20%, preferentially between 0-15%, and particularly preferentially between 0-10%.

According to a further possibility, it can be provided that in this process the isocyanate index is between 0.5-10, preferentially between 1-3, and particularly preferentially between 1.5 and 2.5.

According to the optional step (c), the UV- and moisture-curing polyurethane hot-melt adhesive composition obtained in step (b) can be converted into a silane-terminated polyurethane by adding an aminosilane or a mercaptosilane.

According to the invention, an aminosilane or a mercaptosilane is used in step (c). This should be understood to mean that at least one aminosilane or one mercaptosilane can be used here, including two, three, four, or even more aminosilanes or mercaptosilanes. Preferentially exactly one aminosilane or exactly one mercaptosilane is used in the process.

The aminosilane is preferentially an aminosilane AS of formula (I).

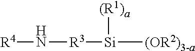

The radical R¹ represents a linear or branched, monovalent hydrocarbon radical with 1-12 carbon atoms, which optionally has one or more C—C multiple bonds and/or optionally cycloaliphatic and/or aromatic moieties. In particular, R¹ represents a methyl, ethyl, or isopropyl group.

The radical R² represents an acyl radical or a linear or branched, monovalent hydrocarbon radical with 1-12 carbon atoms, which optionally has one or more C—C multiple bonds and/or optionally cycloaliphatic and/or aromatic moieties. The radical R² preferentially represents an acyl or alkyl group with 1-5 carbon atoms, in particular a methyl or an ethyl or an isopropyl group.

The radical R³ represents a linear or branched, divalent hydrocarbon radical with 1-12 carbon atoms, which optionally has cyclic and/or aromatic components and optionally one or more heteroatoms. The radical R³ preferentially represents an alkylene radical with 1-3 carbon atoms, in particular with 3 carbon atoms.

Furthermore, index a stands for a value of 0, 1, or 2, in particular 0 or 1.

The radical R⁴ represents a hydrogen atom or a linear or branched hydrocarbon radical with 1-20 carbon atoms, which optionally has cyclic components, or represents a radical of the formula (II).

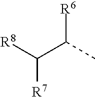

The radicals Re and R⁷ independently represent a hydrogen atom or a radical from the group comprising —R⁹, —CN and —COOR⁹.

The radical R⁸ is hydrogen or a radical selected from the group consisting of —CH₂—COOR⁹, —COOR⁹, —CONHR⁹, —CON(R⁹)₂, —CN, —NO₂, —PO(OR⁹)₂, —SO₂R⁹ and —SO₂OR⁹.

The radical R⁹ represents a hydrocarbon radical with 1 to 20 carbon atoms, optionally containing at least one heteroatom.

Examples of suitable aminosilanes AS of formula (I) are primary aminosilanes such as 3-aminopropyltrimethoxysilane, 3-aminopropyldimethoxymethylsilane, secondary aminosilanes such as N-butyl-3-aminopropyltrimethoxysilane, N-phenyl-3-aminopropyltrimethoxysilane, the products from Michael-type addition of primary aminosilanes such as 3-aminopropyltrimethoxysilane or 3-aminopropyldimethoxymethylsilane to Michael acceptors such as acrylonitrile, acrylic and methacrylic acid esters, acrylic or methacrylic acid amides, maleic and fumaric acid diesters, citraconic acid diesters and itaconic acid diesters, for example N-(3-trimethoxysilyl-propyl)-amino-succinic acid dimethyl esters and diethyl esters, as well as analogues of the above-mentioned aminosilanes with ethoxy or isopropoxy groups in place of the methoxy groups on the silicon. Particularly suitable aminosilanes AS are secondary aminosilanes, in particular aminosilanes AS, in which R4 in formula (I) is different from H. The Michael-type adducts, in particular N-(3-trimethoxysilyl-propyl)-amino-succinic acid diethyl ester, are preferred.

In the present document, the term “Michael acceptor” refers to compounds which, due to the double bonds they contain and activated by electron acceptor residues, are capable of entering into nucleophilic addition reactions with primary amino groups (NH₂ groups) in a manner analogous to the Michael addition (hetero-Michael addition).

In another aspect, the invention relates to a UV- and moisture-curable polyurethane hot-melt adhesive composition producible or prepared by the process disclosed above.

A further advantage can be achieved within the scope of the invention if the polyurethane hot-melt adhesive composition has a viscosity of 10 mPa·s to 150,000 mPa·s at 120 °C. The viscosity is preferentially between 1,000 and 100,000 mPa·s, more preferentially between 3,000 and 75,000 mPa·s, and particularly preferable between 2,000 and 50,000 mPa·s.

Also an object of the invention is the use of the UV- and moisture-curing polyurethane hot-melt adhesive composition of the invention as an adhesive, sealant, or coating agent. In particular, it is intended for use as an adhesive.

The invention also includes a process for the production of a 1K polyurethane adhesive comprising the following steps:
a) Provision of the polymer composition of the invention, in which, during its production, instead of increasing the temperature in optional step c), the polymer is cooled to a temperature of 80 °C to 20 °C
b) Addition of a polyisocyanate according to the invention to achieve a desired free isocyanate content and isocyanate index
c) Optional cooling to a temperature of 80 °C to 20 °C for a period of 0.5-5 hours

Commercially available polyisocyanates, in particular alphiphatic diisocyanates, can be used as polyisocyanates, preferentially diisocyanates, for the production of the polyurethane polymer.

It may be further possible that the polyisocyanate is selected from the group consisting of ethylene diisocyanate, ethylidene diisocyanate, propylene diisocyanate, butylene diisocyanate, pentamethylene diisocyanate, hexamethylene diisocyanate, toluene diisocyanate, cyclopentylene-1,3-diisocyanate, cyclohexylene-1,4-diisocyanate, cyclohexylene-1,2-diisocyanate, 4,4′-diphenylmethane diisocyanate, 2,4′-diphenylmethane diisocyanate, 2,2′-diphenylmethane diisocyanate,4,4′-diisocyanatodicyclohexylmethane, 2,2-diphenylpropane-4,4′-diisocyanate, p-phenylene diisocyanate, m-phenylene diisocyanate, xylylene diisocyanate, 1,4-naphthylene diisocyanate, 1,5-naphthylene diisocyanate, diphenyl-4,4′-diisocyanate, azobenzene-4,4′-diisocyanate, diphenylsulfone-4,4′-diisocyanate, dichlorohexamethylene diisocyanate, furfurylidene diisocyanate, 1-chlorobenzene-2,4-diisocyanate, 4,4′,4″-triisocyanato-triphenylmethane, 1,3,5-triisocyanato-benzene, 2,4,6-triisocyanato-toluene and 4,4′-dimethyldiphenylmethane-2, 2′,5,5-tetraisocyanate, 3-isocyanate-methyl-3,5,5-trimethylcyclohexylisocyanate, 1,3-bis(isocyanatomethyl)benzene, 1,3-bis(isocyanatomethyl)cyclohexane, block diisocyanates and carbodiimide-modified polyisocyanates, polymeric diphenylmethane diisocyanate (PMDI), and any mixtures of the above isocyanates.

In a preferred embodiment, a diphenyl methane isocyanate (MDI) or polymeric diphenyl methane diisocyanate (PMDI) are used as the polyisocyanate.

The MDI can be a mixture of two or three of its isomers, namely 2,2′-diphenylmethane diisocyanate, 2,4′-diphenylmethane diisocyanate, or 4,4′-diphenylmethane diisocyanate. However, only one isomer can be used, which is then preferentially the 4,4′-diphenylmethane diisocyanate.

Polymeric diphenylmethane diisocyanate (PMDI), also known as technical MDI, is a mixture of methylene diphenyl isocyanates and homologous aromatic polyisocyanates. However, the term “polymeric diphenylmethane diisocyanate” is actually technically incorrect, as it is not a polymer, but rather a mixture of compounds with several (typically up to 6) phenylene groups, each of which has an isocyanate group. A common trade name is also polymethylene polyphenyl isocyanate.

According to an advantageous further development of the invention, it can be provided that the free isocyanate content set in step b) of the process is between 2 and 40%, preferentially between 5 and 30/a, and particularly preferentially between 10 and 20%.

Furthermore, it is conceivable within the scope of the invention that the isocyanate index set in step b) of the process is between 1.5 and 20, preferentially between 2 and 15, and particularly preferentially between 4 and 10.

In another aspect, the invention relates to a 1K polyurethane adhesive that can be produced or is produced by the process disclosed above.

According to a further possibility, it can be provided that the 1K polyurethane adhesive has a viscosity of 5,000-25,000 mPa·s, and preferentially from 6,000-21,000 mPa·s, measured at 20 °C.

Also an object of the invention is a use of the 1K polyurethane adhesive of the invention as an adhesive, coating compound, or sealant, in particular as a multi-purpose adhesive, assembly adhesive, construction adhesive, paper and packaging adhesive, film laminating adhesive, adhesive for ceramic and metallic materials, wood, glass, sandwich systems, textiles, reinforcing fabrics, materials in the field of aircraft, military, or shipbuilding.

In a further aspect, the invention relates to a polyurethane composition comprising
a) 5-90 percent by weight of a urethane polymer or urethane prepolymer prepared by additive polymerization of a polyisocyanate and a polyol
b) 10-95 percent by weight of a low-molecular-weight polymer of ethylenically unsaturated monomers that do not contain active hydrogen, at least one of the monomers being an ethylenically unsaturated monomer having a siloxane group

In one embodiment of the invention, the polyurethane composition is characterized in that the low-molecular-weight polymer consists of more than 50%, preferentially more than 75%, and further preferentially 100% of an ethylenically unsaturated monomer with a siloxane group.

In a preferred embodiment of the invention, the polyurethane composition is characterized in that the ethylenically unsaturated monomer with a siloxane group is a silane-modified acrylate.

In a second aspect, the invention relates to the use of an ethylenically unsaturated monomer with a siloxane group for copolymerization with ethylenically unsaturated monomers that do not contain active hydrogen in a polyol or in a prepolymer with the terminal NCO groups as a solvent.

In one embodiment of the invention, the use is characterized in that the ethylenically unsaturated monomer with a siloxane group is a silane-modified acrylate.

In an additional aspect, the invention relates to an acrylate copolymer comprising:
a) 5-95 percent by weight of one or more acrylate monomers that do not contain active hydrogen, preferentially selected from the group consisting of butyl methacrylate and methyl methacrylate
b) 5-95 percent by weight of one or more acrylate monomers with a siloxane side group, preferentially a 3-methacryloxypropyltrimethoxysilane

In a further aspect, the invention relates to a process for producing a 2K polyurethane adhesive, whereby the process comprises the following steps:
a. Provision of the polymer composition according to the invention, wherein instead of increasing the temperature in optional step b. of the process, the polymer is cooled to a temperature of 80 °C to 20 °C and the polymer composition has epoxy groups, either introduced through one of the monomers A to C, which additionally have an epoxy group as a functional group or introduced through a further ethylenically unsaturated monomer which does not contain any active hydrogen and has an epoxy group as a functional group (monomer type D)
b. Addition of a polyisocyanate to achieve a desired free isocyanate content and isocyanate index
c. Optional cooling to a temperature of 80 °C to 20 °C for a period of 0.5-5 hours

Through these process steps a. to c, the first component of the 2K polyurethane adhesive is produced, which can then be reacted with an epoxy-reactive monomer or prepolymer as the second component of the 2K polyurethane adhesive.

In the claimed process for producing a 2K polyurethane adhesive, the second epoxy-reactive component is preferentially an amine compound. The person skilled in the art can use the known amine compounds that are suitable for reacting with the epoxide, such as diamines, polyamines, aliphatic amines, aromatic amines, primary amines or secondary amines. Furthermore, a prepolymer having terminal reactive groups such as amine group, hydroxy group and thiol group can be used, whereby prepolymer having terminal isocyanate groups can be used.

In a further aspect, the invention relates to a 2K polyurethane adhesive that has been produced by the method described above.

Also an object of the invention is a use of the 2K polyurethane adhesive of the invention as an adhesive, coating compound, or sealant, in particular as a multi-purpose adhesive, assembly adhesive, construction adhesive, paper and packaging adhesive, film laminating adhesive, adhesive for ceramic and metallic materials, wood, glass, sandwich systems, textiles, reinforcing fabrics, materials in the field of aircraft, military, or shipbuilding.

### DEFINITIONS

In the present document, substance names beginning with “poly” such as polyol or polyisocyanate refer to substances that formally contain two or more of the functional groups appearing in their name per molecule.

In the present document, the term “polymer” includes not only a collective of chemically uniform but differing macromolecules in terms of degree of polymerization, molar mass and chain length, which has been produced by a polyreaction (polymerization, polyaddition, polycondensation), but also derivatives of such a collective of macromolecules from polyreactions, i.e., compounds obtained by conversions, such as additions or substitutions, of functional groups on given macromolecules, which may be chemically uniform or chemically non-uniform. The term also includes copolymers and so-called prepolymers, i.e., reactive oligomeric pre-adducts whose functional groups are involved in the formation of macromolecules.

The term “copolymer” as used herein refers to a polymer that is composed of two or more different monomer units. This means that the copolymer differs from a homopolymer, which is made up of only one type of monomer (real or assumed) and therefore only has one repeating unit. Copolymers can be divided into five classes:
1.) Statistical copolymers in which the distribution of the two monomers in the chain follows a statistical distribution
2.) Gradient copolymers, which are similar in principle to statistical copolymers, but in which the proportion of one monomer increases and the proportion of the other decreases over the course of the chain
3.) Alternating copolymers, in which the two monomers alternate
4.) Block copolymers and segment copolymers, which consist of longer sequences or blocks of each monomer
5.) Graft copolymers, in which blocks of one monomer are grafted onto the backbone of another monomer

The term “polyurethane polymer” includes all polymers that are produced using what is called the diisocyanate polyaddition process. This also includes polymers that are almost or completely free of urethane groups. Examples of polyurethane polymers are polyether polyurethanes, polyester polyurethanes, polyether polyureas, polyureas, polyester polyureas, polyisocyanurates, and polycarbodiimides.

In this document, an “active hydrogen” is understood to mean a hydrogen bound to N, O, or S (also referred to synonymously as “Zerewitinoff active hydrogen”) if it produces methane by reaction with methyl magnesium iodide according to a process discovered by Zerewitinoff. Typical examples of compounds with active hydrogen are compounds that contain carboxyl, hydroxyl, amino, imino, or thiol groups as functional groups.

Accordingly, the monomer that does not contain active hydrogen (monomer type B) is a monomer that does not have any carboxyl, hydroxyl, amino, imino, or thiol groups.

According to the present application, a “functional group” is a group of atoms in an organic compound that significantly determines the material properties and the reaction behavior of the compound carrying it. Chemical compounds that carry the same functional groups are grouped into substance classes due to their often similar properties.

In this document, a “moisture-reactive functional group” is understood to mean a functional group that reacts with water. This reaction can lead to the cross-linking of two or more such groups and thus lead to the curing of the corresponding polymer. In the field of polymers, the person skilled in the art is familiar with moisture-reactive (curable) groups. Examples include the silane group and the isocyanate group.

In this document, a “UV-curing composition” is understood to mean a polymer composition (preferentially a polyurethane adhesive) that cures at least partially upon irradiation with UV light due to the presence of radical photoinitiator groups in the polymer.

A “radical photoinitiator group” is defined in the context of the present invention as a functional group that decomposes in a photolysis reaction after absorption of UV light and thus forms radicals as reactive species that can start (initiate) a polymerization reaction.

The term “UV light” is defined according to the present invention as light with a wavelength of less than 400 nm. Sub-ranges of the UV light used here are UVA radiation with a wavelength of between 315 nm and 400 nm, UVB radiation with a wavelength of between 280 nm and 315 nm and UVC radiation with a wavelength of between 100 nm and 280 nm.

Preferentially, UVA and/or UVB radiation is used for UV-induced photolysis and thus for UV-induced curing.

In the present document, the terms “silane” and “organosilane” refer to compounds that have not only at least one, usually two, or three, alkoxy groups or acyloxy groups bonded directly to the silicon atom through Si—O bonds but also at least one organic radical bonded directly to the silicon atom through an Si—C bond. Such silanes are also known to the person skilled in the art as organoalkoxysilanes or organoacyloxysilanes.

Accordingly, the term “silane group” refers to the silicon-containing group bound to the organic residue of the silane bound by the Si—C bond. The silanes or their silane groups, respectively, hydrolyze upon contact with moisture and are therefore among the moisture-reactive groups.

“Aminosilanes” or “mercaptosilanes” are organosilanes whose organic residue has an amino group or a mercapto group. “Primary aminosilanes” are aminosilanes that have a primary amino group, i.e., an NH2 group that is bound to an organic residue. “Secondary aminosilanes” are aminosilanes that have a secondary amino group, i.e., an NH group that is bonded to two organic residues.

In this document, “molecular weight” means the molar mass (in grams per mole or in Daltons) of a molecule. In this document, “average molecular weight” is always understood to mean the number-average of the molecular weight distribution Mn (number average). The term “number-average molecular weight” is also used as a synonym for “average molecular weight.”

In this document, a “low molecular weight polymer” is understood to mean a polymer with an average molecular weight Mn of less than 200,000 g/mol. The average molecular weight M, is preferentially less than 100,000 g/mol, particularly preferentially less than 80,000 g/mol, still more preferentially less than 60,000 g/mol and in particular less than 20,000 g/mol. The low molecular weight polymer can, for example, have an average molecular weight Mn of 3,000, 4,000, 5,000, 6,000, 7,000, 8,000, 9,000, 10,000, 15,000, 20,000, 25,000, 30,000, 35,000, 40,000, 45,000, 50,000, 55,000, 60,000, 65,000, 70,000, 75,000, 80,000, 85,000, 90,000, 95,000 and 100,000 g/mol.

The term “polymeric diphenylmethane diisocyanate” (PMDI) refers to a substance mixture of methylene diphenyl isocyanates and homologous aromatic polyisocyanates. The term “polymeric diphenylmethane diisocyanate” is a misnomer from a chemical perspective, as it is not a polymer, but rather a mixture of compounds with several (typically up to 6) phenylene groups, each of which has an isocyanate group. A common trade name is also polymethylene polyphenyl isocyanate.

For the purposes of the present application, a “chain transfer agent” is defined as an organic molecule capable of performing chain transfer. A chain transfer reaction is a reaction in the course of a chain polymerization in which the activity of a growing polymer chain is transferred to another molecule. Chain transfer reactions reduce the average degree of polymerization of the finished polymer. The person skilled in the art is familiar with chain transfer agents for radical polymerizations.

In this document, the term “solvent” is understood to mean compounds as listed as organic solvents in CD Römpp Chemie Lexikon, 9th edition, version 1.0, Georg Thieme Verlag, Stuttgart 1995. The polyols or prepolymers with terminal NCO groups used according to the invention are not covered by this definition, although they act as solvents for the monomers and also the low-molecular-weight polymer formed by radical polymerization.

In the present document, “solid” means substances that do not change their shape without external influence or are difficult to deform, but in particular they are not flowable. Accordingly, “liquid” refers to substances that can be deformed and flow, which also includes highly viscous and pasty substances.

In this document, “one-component” (abbreviated as “1K”) refers to a composition in which all components of the composition are stored mixed in the same container and which is curable with moisture. In the present document, “two-component” refers to a composition in which the components of the composition are present in two different components, which are stored in separate containers. Only shortly before or during application of the composition are the two components mixed together, whereupon the mixed composition hardens, with the curing taking place or being completed only through the action of moisture.

It should be expressly pointed out that in the context of the present patent application, indefinite articles and indefinite numbers such as “one . . . ,” “two . . . ” etc. should generally be understood as minimum information, i.e., as “at least one . . . ,” “at least two . . . ” etc., unless it is clear from the context or the specific text of a particular passage that only “exactly one . . . ,” “exactly two . . . ” etc. is meant. Furthermore, all numerical indications as well as indications of process parameters and/or device parameters are to be understood in the technical sense, i.e., as having the usual tolerances. In addition, the explicit indication of the restriction “at least” or “at a minimum” or similar should not give rise to the assumption that the simple use of “one,” i.e., without the indication of “at least” or similar, means “exactly one.”

Unless otherwise stated, the percentages in this document are percentages by weight.

The embodiments shown here represent only examples of the present invention and should therefore not be construed as limiting. Alternative embodiments contemplated by the person skilled in the art are equally included within the scope of the present invention.

### IMPLEMENTATION EXAMPLES

1. Production of a UV-Curing Polyacrylate as a Base Formulation Based on the formulation of a polyacrylate IC2068 (see Table 1), the copolymerizable photoinitiator 4-methacryloxybenzophenone was varied in proportions of 1-5% in these experiments, thus producing the polyacrylate batches IC2068-7 to IC2068-11. The ratio of diethylhexyl acrylate to 4-methacryloxybenzophenone changes from 12:1 to 2.4:5.

To produce a radiation-curing polyacrylate (and alternatively a polysilane acrylate), the solvent polyether polyol is heated to 90 °C in a glass reactor under a nitrogen atmosphere. During heating, the monomers and the initiator are added within 30 minutes. As soon as the temperature reaches 90 °C, stirring is done for another 30 minutes. The monomers and the initiator are then added within 2 hours at 90 °C. The subsequent reaction then takes place within 2 hours with further dosing of the initiator.

TABLE 1
Polyacrylate batches IC2068-07 to -11

| Raw materials | IC2068-7 | IC2068-8 | IC2068-9 | IC2068-10 | C2068-11 |
|---|---|---|---|---|---|
| PPG 1000 | 58.0 | 58.0 | 58.0 | 58.0 | 58.0 |

Start reaction

| | | | | | |
|---|---|---|---|---|---|
| N-butyl methacrylate | 6.8 | 7.0 | 7.2 | 7.5 | 7.9 |
| 2-ethylhexyl acrylate | 3.4 | 3.4 | 3.4 | 3.4 | 3.4 |
| 4- | 1.4 | 1.15 | 0.9 | 0.6 | 0.3 |
| methacryloxybenzophenone | | | | | |
| Lauryl mercaptan | 0.2 | 0.2 | 0.2 | 0.2 | 0.2 |
| Dimethyl-2,2′- | 0.5 | 0.5 | 0.5 | 0.5 | 0.5 |
| azobisisobutyrate | | | | | |

Dosage

| | | | | | |
|---|---|---|---|---|---|
| Dimethyl-2,2′- | 0.25 | 0.25 | 0.25 | 0.25 | 0.25 |
| azobisisobutyrate | | | | | |
| N-butyl methacrylate | 17.0 | 17.8 | 18.6 | 19.3 | 19.9 |
| 2-ethylhexyl acrylate | 8.6 | 8.6 | 8.6 | 8.6 | 8.6 |
| 4- | 3.6 | 2.85 | 2.1 | 1.4 | 0.7 |
| methacryloxybenzophenone | | | | | |

Post-reaction

| | | | | | |
|---|---|---|---|---|---|
| Dimethyl-2,2′- | 0.25 | 0.25 | 0.25 | 0.25 | 0.25 |
| azobisisobutyrate | | | | | |

(PPG 1000 = polypropylene glycol MW = 1000)

The viscosity barely differs within the test series (see Table 2). Tack measurements using an oscillation and rotation rheometer also verify the assumption that the proportion of 4-methacryloxybenzophenone used initially has little influence on the technical parameters.

### 2. Rheological Characterization of UV-Curing Polyacrylates

The polyacrylates IC2068-7 to IC2068-11 prepared according to Table 1 were rheologically investigated. First, the viscosity was determined at a temperature of 90 °C in a Brookfield-CAP2000+ viscometer (AMETEK GmbH, Meerbusch, Germany). In addition, the stickiness (called “tack”) was also determined at a polymer temperature of 90 °C in an oscillation and rotation rheometer MCR 302 (Anton Paar, Graz, Austria) under the following measuring conditions: measuring plate PP2, gap: 0.1 mm, pre-shear 1000 1/s. The results are given in Table 2.

TABLE 2
Measurement results for the polyacrylates of test series IC2068

| | Brookfield- | |
|---|---|---|
| | Cap2000+ | Rheometer |
| | Viscosity @ | Tack @ 90 °C |
| Test No. | 90 °C [mPa · s] | [Nmm] |
| IC2068-7 | 2,200 | 0.13 |
| IC2068-8 | 2,000 | 0.13 |
| IC2068-9 | 2,000 | 0.13 |
| IC2068-10 | 1,800 | 0.10 |
| IC2068-11 | 1,800 | 0.10 |

As the results shown in Table 2 show, the viscosity hardly differs within the test series. Tack measurements using an oscillation and rotation rheometer also verify the assumption that the proportion of 4-methacryloxybenzophenone used has little initial influence on the technical parameters of the polyacrylate polymer. This provides the technological basis for the production of silane-modified polyacrylates.

### 3. Conversion of UV-Curing Polyacrylates to Polyurethane

To produce a polyurethane adhesive, the polyacrylates IC2068-7 to IC2068-11 prepared according to Table 1 were reacted with 4,4′-diphenylmethane diisocyanate (4,4′-MDI) and additives (UV markers, defoamers, stabilizers) according to Table 3 to form the UV-curable polyurethane prepolymers UV-10 to UV 14. Additional polyols and additives can be added to the polyacrylate/polysilane acrylate at 90 °C. Homogenization takes place for 45 minutes at approx. 10 mbar. The 4,4′-MDI is then added and stirred for 60 minutes. Before the polyurethane adhesive is filled, it is degassed again at approx. 10 mbar.

TABLE 3
Test approaches UV 10 to UV 14

| | Raw materials | | | | |
|---|---|---|---|---|---|
| | UV 10 | UV 11 | UV 12 | UV 13 | UV 14 |
| 2068-7 | 78.8 | | | | |
| 2068-8 | | 78.8 | | | |
| 2068-9 | | | 78.8 | | |
| 2068-10 | | | | 78.8 | |
| 2068-11 | | | | | 78.8 |
| Additives | 0.2 | 0.2 | 0.2 | 0.2 | 0.2 |
| 4,4′-MDI | 21.0 | 21.0 | 21.0 | 21.0 | 21.0 |

### 4. Rheological Characterization of UV-Curing Polyurethanes

The polyurethane adhesives UV 10 to UV 14 prepared according to Table 31 were rheologically investigated. First, the viscosity was determined in a Brookfield-CAP2000+ viscometer (AMETEK GmbH, Meerbusch, Germany) at a temperature of 90 °C (spindle 1.5 rpm). In addition, the stickiness (called “tack”) was also determined at a polymer temperature of 90 °C in an oscillation and rotation rheometer MCR302 under the following measuring conditions: measuring plate PP12, gap: 0.1 mm, pre-shear 1000 1/s. The results are given in Table 4.

TABLE 4
Measurement results for polyurethane adhesives UV 10 to UV 14

| | Brookfield- | |
|---|---|---|
| | Cap2000+ | Rheometer |
| | Viscosity @ | Tack @ 90 °C |
| Test No. | 90 °C [mPa · s] | [Nmm] |
| UV 10 | 3,800 | 0.40 |
| UV 11 | 3,700 | 0.30 |
| UV 12 | 4,600 | 0.45 |
| UV 13 | 3,600 | 0.30 |
| UV 14 | 3,800 | 0.45 |

As the measurement results in Table 4 show, the UV-active polyurethane adhesives UV 10 to UV 14 have a low viscosity when applied at 90 °C and are characterized by low inherent tack.

### 5. UV-Induced Bonding of UV-Curing Polyurethanes

The effectiveness of UV activity within the test series UV 10 to 14 was investigated in more detail using a 180° peel test and a loop tack test (based on DIN EN 1713) using a traction machine (see FIGS. 1 and 2). Adhesives were applied to an aluminum foil (foil thickness=30 μm) in a layer thickness of 50 μm at 90 °C, exposed to UV light (UV belt dryer UN50029, Technigraf, Gräfenwiesbach, Germany, wavelength range=200 nm to 400 nm), then glued directly to a glass plate and rolled with a 2 kg hand roller. After 10 minutes, the tests were done on the traction machine. With a UV exposure time of 10 s, an energy quantity of approx. 800 J/cm is generated, whereas with 20 s an energy quantity of approx. 1,600 J/cm is generated.

The results shown in FIGS. 1 and 2 can be summarized as follows: The higher the proportion of photoinitiator, the lower the energy input required over UV exposure and the less the yellowing of the polyurethane adhesive develops. UV 10 therefore represents the optimal formulation, especially in terms of the 5-fold increase in surface tack and the increase in adhesive strength. The successful findings were successfully transferred to the use of UV silane acrylates in the PU system. This was produced according to a further experiment.

### 6. Preparation of a UV-Curing Silane-Modified Polyacrylate

Based on the polymerization of acrylate polymers in polyols, the base formulation 012068-8 according to Table 1 was modified by the use of a silane-containing methacrylate monomer to obtain the UV and moisture-curable silane-acrylate 3.2068-12. The organofunctional 3-methacryloxypropytrimethoxysilane was used at 3.0%. The recipe and the reaction control are shown in Table 5.

To produce a silane-modified acrylate polymer, the sample is heated to 90 °C in a glass reactor under a nitrogen atmosphere. After 30 minutes, the monomers are metered in over 2 hours at 90 °C and the initiator is added. The secondary reaction then takes place within 2 hours with further addition of the initiator.

TABLE 5
Formulation of the UV-curing silane-modified acrylate UV2068-12

| | IC2068-8 | |
|---|---|---|
| Raw materials | (basis) | IC2068-12 |
| PPG 1000 | 58.0 | 58.0 |

Start reaction

| | | |
|---|---|---|
| N-butyl methacrylate | 7 | 4.9 |
| 2-ethylhexyl acrylate | 3.4 | 2.5 |
| Methacryloxypropyltrimethoxysilane | 0 | 3.0 |
| 4-methacryloxybenzophenone | 1.15 | 1.0 |
| Lauryl mercaptan | 0.2 | 0.2 |
| Dimethyl-2,2′-azobisisobutyrate | 0.5 | 0.5 |

Dosage

| | | |
|---|---|---|
| Dimethyl-2,2′-azobisisobutyrate | 0.25 | 0.25 |
| N-butyl methacrylate | 17.8 | 12.3 |
| 2-ethylhexyl acrylate | 8.6 | 6.2 |
| Methacryloxypropyltrimethoxysilane | 0 | 7.8 |
| 4-methacryloxybenzophenone | 2.85 | 2.6 |

Post-reaction

| | | |
|---|---|---|
| Dimethyl-2,2′-azobisisobutyrate | 0.25 | 0.25 |

### 7. Rheological Characterization of UV-Curing Silane-Modified Polyacrylates

The UV-curing silane-modified polyacrylate variant IC2068-12 was also rheologically tested using the same method in comparison to the base formulation IC2068-8:

TABLE 6
Measurement results for the UV-curing
silane-modified polyacrylate IC2068-12

| | Brookfield- | |
|---|---|---|
| | Cap2000+ | Rheometer |
| | Viscosity @ | Tack @ 90 °C |
| Test No. | 90 °C [mPa · s] | [Nmm] |
| IC2068-8 (basis) | 2,000 | 0.13 |
| IC2068-12 | 1,500 | 0.07 |

Similar properties can be found through rheological investigations.

### 8. Conversion of UV-Curing Silane-Modified Polyacrylates to Polyurethane

To produce a polyurethane adhesive, the polyacrylate IC2068-12 prepared according to Table 5 was reacted with 4,4′-diphenylmethane diisocyanate (4,4′-MDI) and additives according to Table 7 to form the UV-curable polyurethane prepolymer UV 15. Additional polyols and additives can be added to the polyacrylate/polysilane acrylate at 90 °C. Homogenization takes place for 45 minutes at approx. 10 mbar. The 4,4′-MDI is then added and stirred for 60 minutes. Before the polyurethane adhesive is filled, it is degassed again at approx. 10 mbar.

TABLE 7
Test approach UV 15

| | UV 11 | |
|---|---|---|
| Raw materials | (basis) | UV 15 |
| 2068-8 | 78.8 | |
| 2068-12 | | 78.8 |
| Additives | 0.2 | 0.2 |
| 4,4′-MDI | 21.0 | 21.0 |

### 9. Rheological Characterization of UV-Curing Silane-Modified Polyurethanes

The polyurethane adhesive UV 15, produced according to Table 7, was also rheologically tested using the same method in comparison to the basic formulation UV 11:

TABLE 8
Measurement results for the UV-curing silane-
modified polyurethane adhesive UV 15

| | Brookfield- | |
|---|---|---|
| | Cap2000+ | Rheometer |
| | Viscosity @ | Tack @ 90 °C |
| Test No. | 90 °C [mPa · s] | [Nmm] |
| UV 11 | 3,700 | 0.30 |
| UV 15 | 6,500 | 0.80 |

Rheological investigations reveal slight modifications in the properties.

### 10. UV-Induced Bonding of UV-Curing Polyurethanes

Using a 180° peel test and a loop tack test (based on DIN EN 1713) and using a traction machine, the adhesive strength as a function of the UV irradiation time for the UV-curing silane-modified polyurethane adhesive UV 15 was investigated in comparison to the basic formulation UV 11 (see FIGS. 3 and 4). Adhesives were applied to an aluminum foil (foil thickness=30 μm) in a layer thickness of 50 μm at 90 °C, exposed to UV light (UV belt dryer UN50029, Technigraf, Gräfenwiesbach, Germany, wavelength range=200 nm to 400 nm), then glued directly to a glass plate and rolled with a 2 kg hand roller. After 10 minutes, the tests were done on the traction machine. With a UV exposure time of 10 s, an energy quantity of approx. 800 J/cm is generated, whereas with 20 s an energy quantity of approx. 1,600 J/cm is generated.

As FIGS. 3 and 4 show, the silane-modified polymer UV 15 shows improved adhesive strength compared to the base formulation UV 11 in both test methods. The optimal UV irradiation time was 20 to 30 seconds.

### FIGURES

Shown are:

FIG. 1 shows the UV-induced bonding using a 180° peel test for the polyurethane adhesives UV 10 to UV 14 prepared according to Table 3. Adhesive strength is shown in Newtons as a function of the UV irradiation time in seconds.

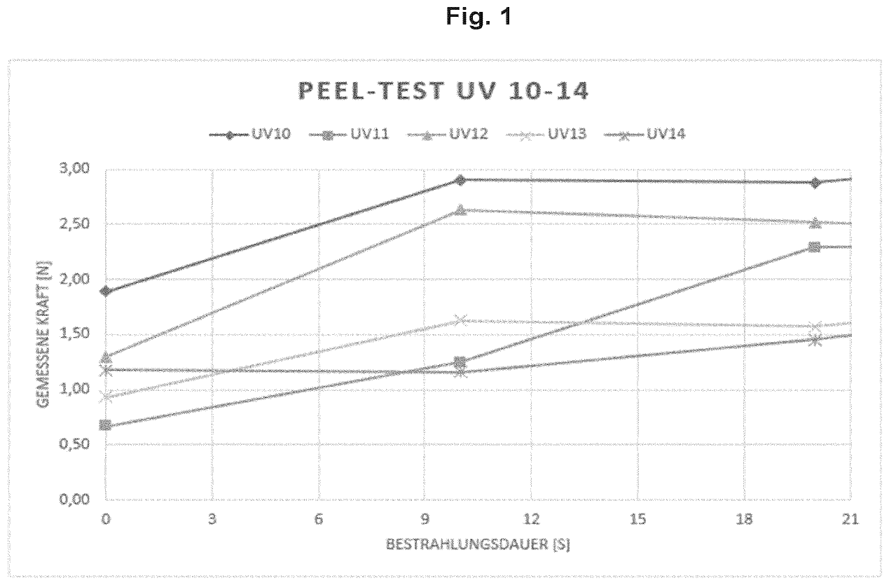

FIG. 2 shows the UV-induced bonding using a loop tack test for the polyurethane adhesives UV 10 to UV 14 prepared according to Table 3. Adhesive strength is shown in Newtons as a function of the UV irradiation time in seconds.

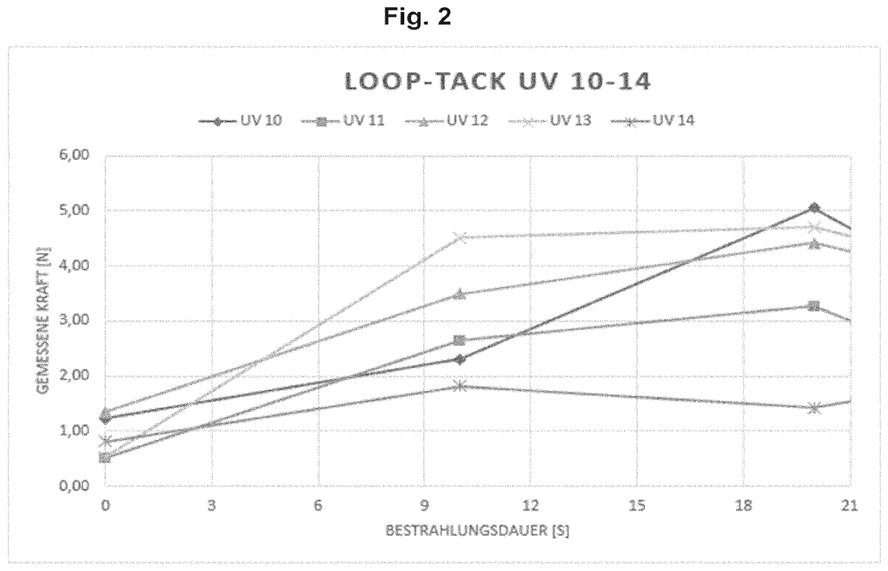

FIG. 3 shows the UV-induced bonding using a loop task test for the polyurethane adhesives UV 11 and UV 15 prepared according to Table 7. Adhesive strength is shown in Newtons as a function of the UV irradiation time in seconds.

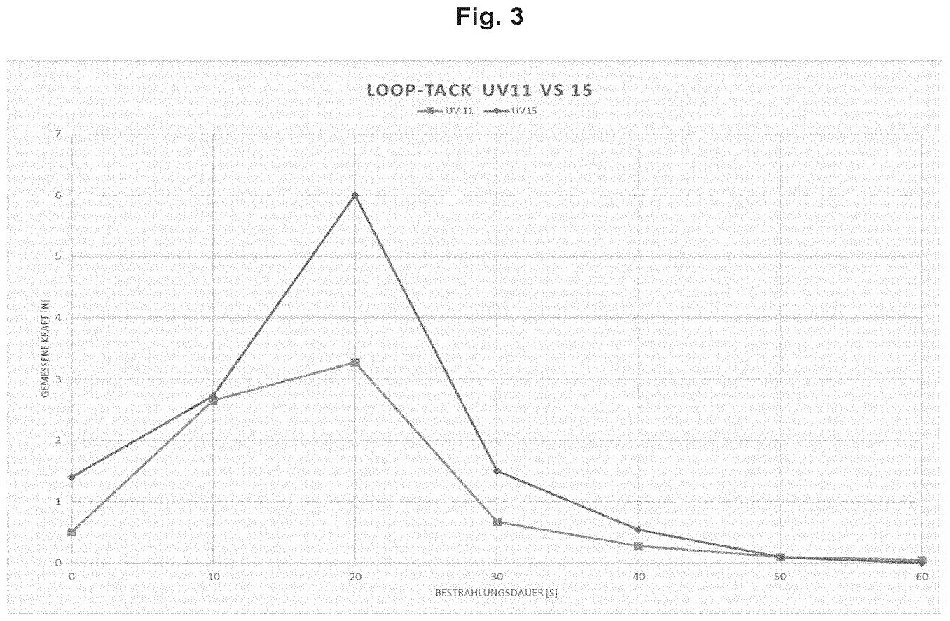

FIG. 4 shows the UV-induced bonding using a 180° peel test for the polyurethane adhesives UV 11 and UV 15 prepared according to the table. Adhesive strength is shown in Newtons as a function of the UV irradiation time in seconds.

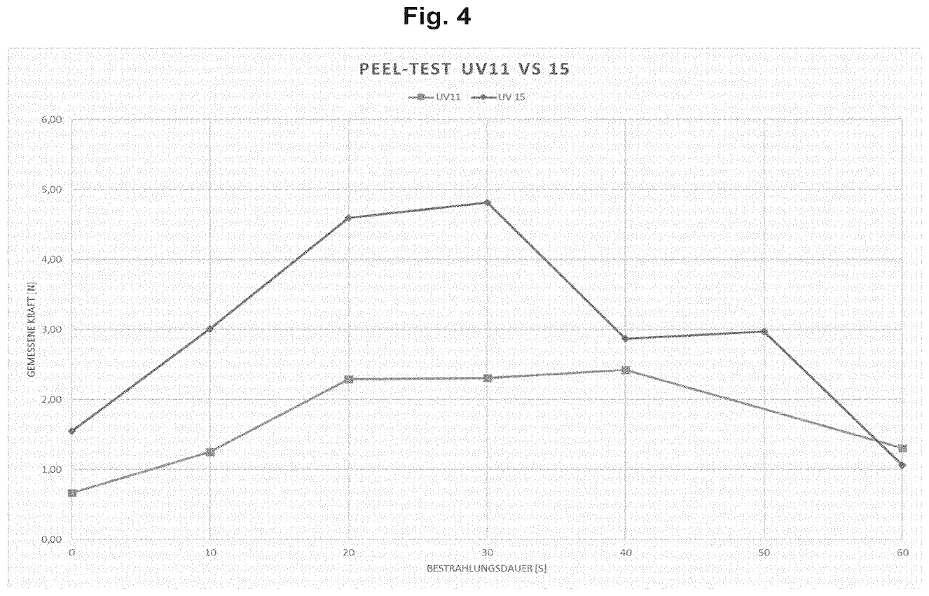

1. A process for producing a polymer composition comprising the following steps:
a) Combination of:
(i) a polyol or a prepolymer with terminal isocyanate (NCO) groups
(ii) an ethylenically unsaturated monomer containing no active hydrogen and having no silane groups (monomer type A), and
(iii) an ethylenically unsaturated monomer containing no active hydrogen and having a silane group (monomer type B)
(iv) an ethylenically unsaturated monomer containing no active hydrogen and having a radical photoinitiator group (monomer type C)
b) Polymerizing the mixture from step a. using a radical polymerization process with a chain transfer agent to obtain a low molecular weight polymer having an average molecular weight Mn of less than 200,000 g/mol
c) Optionally heating the mixture from step b) to a temperature of 100 °C to 160 °C for 10 to 60 minutes for partial cross-linking of the polyol with the low molecular weight polymer having an average molecular weight Mn of less than 200,000 g/mol

2. A process according to claim 1, characterized in that the polyol is selected from the group consisting of polyester, polyether polyols such as polyethylene oxide or a polypropylene oxide, hydroxyl group-containing polycaprolactone, polyoxyalkene polyol, monosubstituted glycol ester, polythioether, polyamide, polyesteramide, polycarbonate, polyacetal, polyhydrocarbon polyol, polyacrylate polyol, polymethacrylate polyol, polyalcohol, bisphenol, polycarbonate polyol, polyhydroxy-functional fats and oils and mixtures thereof, wherein the polyol is preferentially a polyether polyol with a molecular weight between 400 and 40,000 Da, a polyethylene oxide or a polypropylene glycol.

3. A process according to claim 1, characterized in that the monomer type A is selected from the group consisting of C1 to C12 esters of acrylic acid or methacrylic acid such as glycidyl acrylate, glycidyl methacrylate, methyl acrylate, ethyl acrylate, n-butyl acrylate, methyl methacrylate, ethyl methacrylate or n-butyl methacrylate, vinyl esters such as vinyl acetate or vinyl propionate, vinyl ethers, fumarates, maleates, styrenes, acrylonitriles, ethylenes, or mixtures thereof, wherein the monomer type A is preferentially n-butyl methacrylate (n-BMA) or methyl methacrylate (MMA) or a mixture thereof.

4. A process according to claim 1, characterized in that the monomer type B is selected from the group consisting of vinyl compounds, acrylates, methacrylates, fumarates, maleates, styrenes, acrylonitriles, ethylenes, or mixtures thereof, which have a silane group.

5. A process according to claim 4, characterized in that the monomer type B is selected from the group consisting of vinyltrichlorosilane, methylvinyldichlorosilane, vinyltriethoxysilane, vinyltrimethoxysilane, vinyltris(2methoxyethoxy)silane, vinyltriacetoxysilane, vinylmethyldiethoxysilane, vinyldimethylethoxysilane, vinylmethyldimethoxysilane, vinyldimethylmethoxysilane, vinylmethyldiacetoxysilane, vinyltriisopropoxysilane, vinyltriisopropenoxysilane, vinyltris(methylethylketoximino)silane, divinyltetramethyldisiloxane, tetravinyltetramethylcyclotetrasiloxane, 3-acryloxypropyldimethylmethoxysilane, 3-acryloxypropyldimethylethoxysilane, 3-acryloxypropyltrimethoxysilane, 3-acryloxypropyltriethoxysilane, 3-methacryloxypropyltrimethoxysilane, 3-methacryloxypropyltriethoxysilane, 3-Methacryloxypropylmethyldiethoxysilane, 3-Methacryloxypropylmethyldimethoxysilane, 3-methacryloxypropyltris(2methoxyethoxy)silane-, 4-(3trimethoxysilylpropyl)benzylstyrenesulfonate, allyltriethoxysilane, allyltrimethoxysilane and oligomers of these silanes, wherein the monomer type B is preferentially methacryloxypropyltrimethoxysilane.

6. A process according to claim 1, characterized in that the monomer type C is a monomer with a radical photoinitiator group of type II, which is preferentially a benzophenone group or an isopropylthioxanthone group and is particularly preferentially selected from the group consisting of 4-methacryloyloxybenzophenone, 4-methacryloyloxyethoxybenzophenone, 4-methacryloyloxy-4′-methoxybenzophenone, 4-methacryloyloxyethoxy-4′-methoxybenzophenone, 4-methacryloyloxy-4′-bromobenzophenone, 4-acryloyloxyethoxy-4′-bromobenzophenone, 4-acryloyloxybenzophenone (ABP), 4-(2-acryloyloxyethoxy)benzophenone (AEBP), 4-(2-acryloyloxybutoxy)benzophenone (ABBP), 4-(2-acryloyloxy-hexoxy)benzophenone (AHBP), and particularly preferentially ABP or 4-methacryloyloxybenzophenone.

7. A process according to claim 1, characterized in that in the radical polymerization process, a peroxide initiator or an azo initiator is used as initiator, which is preferentially selected from the group consisting of dilauroyl peroxide, dibenzoyl peroxide, dimethyl 2,2′-azobisisobutyrate, di-(4-tert-butyl-cyclohexyl)-peroxydicarbonate and azobis(isobutyronitrile).

8. A process according to claim 1, characterized in that the chain transfer agent is an organohalogen compound, an unsaturated aromatic compound or a thiol, which is preferentially selected from the group consisting of tetrachloromethane, 2,4-diphenyl-4-methyl-1-pentene, dodecyl mercaptan (DDM), thioglycolic acid, octylthioglycolate, and thioglycerol, and particularly preferentially dodecyl mercaptan.

9. A process according to claim 1, characterized in that the polyol or the prepolymer with terminal NCO groups is obtained in an amount of 20 percent by weight to 90 percent by weight, preferentially from 40 percent by weight to 80 percent by weight and particularly preferentially from 50 percent by weight to 60 percent by weight on the total weight of the components polyol or prepolymer, monomer type A to C.

10. A process according to claim 1, characterized in that monomer type A in an amount of 30 percent by weight to 95 percent by weight, preferentially from 50 percent by weight to 90 percent by weight and particularly preferentially from 70 percent by weight to 85 percent by weight, based on the total weight of monomer types A, B and C is present.

11. A process according to claim 1, characterized in that monomer type B in an amount of 5 percent by weight to 70 percent by weight, preferentially from 10 percent by weight to 50 percent by weight and particularly preferentially from 15 percent by weight to 30 percent by weight, based on the total weight of monomer types A, B and C is present.

12. A process according to at claim 1, characterized in that monomer type C in an amount of 0.1 percent by weight to 5.0 percent by weight, preferentially from 0.2 percent by weight to 4.0 percent by weight and particularly preferentially from 0.3 percent by weight to 3.0 percent by weight, based on the total weight of monomer type A and monomer types A, B and C is present.

13. A process according to claim 1, characterized in that the low-molecular-weight polymer has a number-average molecular weight of 3,000-200,000 g/mol, preferentially of 5,000-100,000 g/mol and particularly preferentially of 10,000-60,000 g/mol.

14. A polymer composition prepared by a process according to claim 1.

15. A polymer composition according to claim 14, characterized in that the polymer composition has a glass transition temperature of between −50 °C and 100 °C, preferentially between −40 °C and 70 °C, and particularly preferentially between −30 °C and 60 °C.

16. A polymer composition according to claim 14, characterized in that the polymer composition has a viscosity of 500-25,000 mPa·s, and preferentially from 1,000-21,000 mPa·s, measured at 90 °C.

17. A polymer composition according to claim 14, characterized in that it is free of solvents.

18. Use of the polymer composition according to claim 14 as an adhesive, sealant, or coating agent, wherein the polymer composition cures as a one-component composition with moisture and by increasing the temperature to more than 100 °C.

19. A process for producing a UV- and moisture-curing polyurethane hot melt adhesive composition comprising the following steps:
a) Provision of a polymer composition according to claim 14
b) Addition of sufficient polyisocyanate to achieve the desired isocyanate content and isocyanate index and polymerization through the use of an additive polymerization process
c) Optional addition of an aminosilane or a mercaptosilane and conversion to a silane-terminated polyurethane
d) Irradiation with UV light to further cross-link the polymer

20. A process according to claim 19, characterized in that the polyisocyanate in step b) is selected from the group consisting of ethylene diisocyanate, ethylidene diisocyanate, propylene diisocyanate, butylene diisocyanate, pentamethylene diisocyanate, hexamethylene diisocyanate (HDI), toluene diisocyanate, cyclopentylene-1,3-diisocyanate, cyclohexylene-1,4-diisocyanate, cyclohexylene-1,2-diisocyanate, 4,4′-diphenylmethane diisocyanate, 2,4′-diphenylmethane diisocyanate, 2,2′-diphenylmethane diisocyanate, 4,4′-diisocyanatodicyclohexylmethane, 2,2-diphenylpropane-4,4′-diisocyanate, p-phenylene diisocyanate, m-phenylene diisocyanate, xylylene diisocyanate, 1,4-naphthylene diisocyanate, 1,5-naphthylene diisocyanate, diphenyl 4,4′ diisocyanate, azobenzene 4,4′ diisocyanate, diphenyl sulfone 4,4′ diisocyanate, dichlorohexamethylene diisocyanate, furfurylidene diisocyanate, 1-chlorobenzene-2,4-diisocyanate, 4,4′,4″-triisocyanato-triphenylmethane, 1,3,5-triisocyanato-benzene, 2,4,6-triisocyanato-toluene and 4,4′-dimethyldiphenylmethane-2,2′,5,5-tetraisocyanate, 3-isocyanate-methyl-3,5,5-trimethylcyclohexylisocyanate, 1,3-bis(isocyanatomethyl)benzene, 1,3-bis(isocyanatomethyl)cyclohexane, polymeric diphenylmethane diisocyanate (PMDI), block diisocyanates and carbodiimide-modified polyisocyanates, and mixtures or precondensates thereof, such as HDI biuret or HDI cyanurate, wherein the polyisocyanate is preferentially an aliphatic isocyanate.

21. A process according to claim 19, characterized in that the free isocyanate content is between 0-20%, preferentially between 0-15%, and particularly preferentially between 0-10%.

22. A process according to claim 19, characterized in that the isocyanate index is between 0.5-10, preferentially between 1-3, and particularly preferentially between 1.5-2.5.

23. UV- and moisture-curing polyurethane hot-melt adhesive composition prepared by a process according to claim 19.

24. UV- and moisture-curing polyurethane hot-melt adhesive composition according to claim 23, characterized in that the composition has a viscosity of 10 mPa·s to 150,000 mPa·s at 120 °C.

25. Use of the UV- and moisture-curing polyurethane hot-melt adhesive composition according to claim 23 as an adhesive, sealant, or coating agent.

26. A process for producing a 1K polyurethane adhesive comprising the following steps:
a) Provision of a polymer composition according to claim 14, wherein instead of increasing the temperature in optional step (b), the polymer is cooled to a temperature of 80 °C to 20 °C
b) Addition of a polyisocyanate to achieve a desired free isocyanate content and a desired isocyanate index
c) Optional cooling to a temperature of 80 °C to 20 °C for a period of 0.5-5 hours

27. A process according to claim 26, characterized in that in step b) a polyisocyanate is used, the polyisocyanate preferentially being an aliphatic diisocyanate.

28. A process according to claim 26, characterized in that the free isocyanate content is between 2-40%, preferentially between 5-30%, and particularly preferentially between 10-20%.

29. A process according to claim 26, characterized in that the isocyanate index is between 1.5-20, preferentially between 2-15, and particularly preferentially between 4-10.

30. A 1K polyurethane adhesive produced by a process according to claim 26.

31. The 1K polyurethane adhesive according to claim 30, characterized in that the 1K polyurethane adhesive has a viscosity of 5,000-25,000 mPa·s, and preferentially from 6,000-21,000 mPa·s, measured at 90 °C.

32. A process for producing a 2K polyurethane adhesive includes the following steps:
a) Provision of a polymer composition according to at claim 14, wherein instead of increasing the temperature in optional step b. the polymer is cooled to a temperature of 80 °C to 20 °C and the polymer composition has epoxy groups, either introduced through one of the monomers A to C, which additionally have an epoxy group as a functional group or introduced through a further ethylenically unsaturated monomer which does not contain any active hydrogen and has an epoxy group as a functional group (monomer type D)
b) Addition of a polyisocyanate to achieve a desired free isocyanate content and isocyanate index
c) Optional cooling to a temperature of 80 °C to 20 °C for a period of 0.5 to 5 hours for producing the first component of the 2K polyurethane adhesive with an epoxy-reactive monomer or prepolymer as the second component of the 2K polyurethane adhesive.

33. A process according to claim 32, characterized in that the second component is an amine compound or a prepolymer having terminal isocyanate, hydroxy, thiol or amine groups.

34. A 2K polyurethane adhesive produced by a process according to claim 32.

35. Use of a 1K polyurethane adhesive according to claim 30 or a 2K polyurethane adhesive according to claim 34 as an adhesive, coating compound or sealant, in particular as a multi-purpose adhesive (household adhesive), assembly adhesive, construction adhesive, paper and packaging adhesive, film laminating adhesive, adhesive for ceramic and metallic materials, wood, glass, sandwich systems, textiles, reinforcing fabrics, materials in the aircraft, military or shipbuilding sectors.
